(19) United States
(12) Patent Application Publication
(10) Pub. No.: US 2015/0010714 A1
(43) Pub. Date: Jan. 8, 2015

(54) ION BEAM PROCESSING OF SIC FOR FABRICATION OF GRAPHENE STRUCTURES

(71) Applicants: Bill R. Appleton, Newberry, FL (US); Brent Paul Gila, Gainesville, FL (US); Sefaattin Tongay, Albany, CA (US); Maxime G. Lemaitre, Gainesville, FL (US)

(72) Inventors: Bill R. Appleton, Newberry, FL (US); Brent Paul Gila, Gainesville, FL (US); Sefaattin Tongay, Albany, CA (US); Maxime G. Lemaitre, Gainesville, FL (US)

(73) Assignee: UNIVERSITY OF FLORIDA RESEARCH FOUNDATION, INC., GAINESVILLE, FL (US)

(21) Appl. No.: 14/236,789

(22) PCT Filed: Aug. 23, 2012
(86) PCT No.: PCT/US2012/052061

§ 371 Date: Feb. 3, 2014

Related U.S. Application Data
(60) Provisional application No. 61/526,510, filed on Aug. 23, 2011.

(51) Int. Cl. C01B 31/04

(52) U.S. Cl. CPC C01B 31/0446; Y10S 977/734; Y10S 977/844; B82Y 40/00
USPC 427/496; 977/734; 977/844

(57) ABSTRACT

A method of preparing graphene on a SiC substrate includes bombarding a surface of the SiC substrate with ions and annealing a volume of the SiC substrate at the bombarded surface to promote agglomeration of carbon at the bombarded surface to form one or more layers of graphene at that surface. The ions can be Si, C, or other ions such as Au. The annealing can be carried out using a thermal source of heating or by irradiation with at least one laser beam or other high energy beam.

### CROSS-REFERENCE TO RELATED APPLICATION

The present application claims the benefit of U.S. Provisional Application Ser. No. 61/526,510, filed Aug. 23, 2011, which is hereby incorporated by reference herein in its entirety, including any figures, tables, or drawings.

This invention was made with government support under Contract No. CHE-0748408 awarded by the National Science Foundation. The government has certain rights in the invention.

### BACKGROUND OF INVENTION

Recently the discovery of graphene, atomically thin layers of graphite (Novoselov et al. “Electric Field Effect in Atomically Thin Carbon Films.” Science 2004, 306(5696): 666-9) allowed the isolation of a single two-dimensional atomic layer of carbon atoms. The strongest covalent bond in nature, the C-C bond, locks these atoms into an array with remarkable mechanical properties (Meyer et al. “The Structure of Suspended Graphene Sheets” Nature 2007, 446(7131) 60-3). A single layer of graphene is one of the stiffest known materials, characterized by a remarkably high Young's modulus of ˜1,000 GPa (Bunch et al. “Electromechanical Resonators from Graphene Sheets” Science 2007, 315(5811) 490-3). A graphene membrane is impermeable to gases, down to the thickness limit of one atomic layer (Bunch et al. “Impermeable Atomic Membranes from Graphene Sheets” Nano Lett. 2008, 8(8), 2458-62). As an electronic material, graphene allows consideration of electrons in 2, 1, and 0 dimensions where properties are novel due to its linear band structure. Scattering is low in graphene, which allows the observation of the Quantum Hall Effect (QHE) (Zhang et al. “Experimental Observation of the Quantum Hall Effect and Berry's Phase in Graphene” Nature 2005 438(7065) 201-4). Hence, graphene is emerging as an enormously promising material for: solid state chemical, gas and biological sensors; nanoelectronics (including FETs, SETs, spin valves, and superconducting FETs); logic and memory; field emitters for plasma displays; batteries; spin qbits; Hall Effect devices; and conducting composite materials, in addition to their use for fundamental QED studies. Fabrication of continuous, large areas of graphene remains a barrier to the introduction of graphene into devices of these types.

The most common method of graphene fabrication is exfoliation. Exfoliation is a technique derived from writing with a graphite pencil where many sheets of graphene are deposited in thicknesses of varied numbers of graphene layers spread on the paper. Novoselov et al. discloses a modification of this approach, where a freshly cleaved graphite crystal is gently rubbed on an oxidized silicon wafer, having a specific thickness of oxide, to yield graphene flakes as single atomic layers that can be observed visibly under an optical microscope due to thin film interference effects. This technique allows one to find single graphene sheets, but is limited to only the tedious fabrication of devices for research purposes. There have been attempts to improve the quality and yield of exfoliated graphene, including: using sticky tape to peel graphene layers and transfer them to a substrate; stamping methods that use silicon pillars to transfer graphene flakes (Liang et al. “Graphene Transistors Fabricated via Transfer-Printing in Device Active-Areas on Large Wafer” Nano Lett. 2007 7(12) 3840-4); and electrostatic voltage assisted exfoliation, which uses electrostatic forces to controllably separate graphene from bulk crystals (Sidorov et al. “Electrostatic Deposition of Graphene” Nanotechnology 2007 (13): 135301).

Another graphene fabrication technique is to disperse graphene from solution (Bunch et al. “Coulomb Oscillations and Hall Effect in Quasi-2D Graphite Quantum Dots” Nano Lett. 2005 5(2) 287-90). This method uses the sonication of graphite flakes in solution and then dispersion of the flakes onto a wafer. An atomic force microscope (AFM) is used to locate individual sheets, which is a very time consuming method relative to the optical detection used for exfoliated graphene. Long sonication times are needed to yield small single layer graphene flakes. A similar technique allows for the fabrication of graphene ribbons with nm-scale widths (Li et al. “Chemically Derived, Ultrasmooth Graphene Nanoribbon Semiconductors” Science 2008 319(5867) 1229-32). One difficulty inherent to methods of dispersing graphene in solution is the separation of the layers without breaking the layers.

A technique that appears to have some potential for mass production of graphene involves heating a SiC wafer to high temperatures to partially graphitize the upper layer or layers (Berger et al. “Ultrathin Epitaxial Graphite: 2D Electron Gas Properties and a Route Toward Graphene-Based Nanoelectronics” J. Phys. Chem. B 2004 108(52) 19912-6; DeHeer et al., U.S. Pat. No. 7,015,142; and DeHeer et al., U.S. Patent Application Publication No. 2006/0099750). However, there are a number of difficulties with approaches using high temperature decomposition of SiC. A first difficulty is that forming C-rich surfaces on SiC single crystals requires heating the samples to very high temperatures in carefully controlled environments. This is costly and generally generates a roughened surface due to a faceting of the crystals, which alters electrical properties in a manner that can be detrimental to subsequent processing of a device and/or sensor. A second difficulty is that of controlling the number of graphene layers generated, and the layers' grain sizes, which to date has yielded limited success at achieving uniform graphene with good mobilities (Berger et al. “Electronic Confinement and Coherence in Patterned Epitaxial Graphene” Science 2006 312(5777) 1191-6 and Hass et al. “Why Multilayer Graphene on 4H-SiC(0001) Behaves Like a Single Sheet of Graphene” Phys. Rev. Lett. 2008, 100, 125504). Consequently, generation of a single graphene sheet is problematic and the graphene sheet is not readily isolated from the SiC substrate. Presently, it is not possible to control where on the substrate a single layer of graphene forms that is suitably flat such that further processing can be carried out to produce a device.

Hence, exfoliation remains the preferred method for most experimental research groups around the world. Wide spread applicability of graphene is limited by the crude time consuming methods currently used to fabricate and isolate single graphene sheets. There remains a need to develop a reliable and reproducible graphene fabrication method that is compatible with commercial semiconductor device fabrication techniques, and that allows graphene to move beyond being a laboratory curiosity. If a SiC substrate approach to the formation of graphene is to be adopted for commercial applications, a lower temperature process is needed, one where the thickness of produced graphene is controllable, and one where the graphene can be fabricated on a substrate at the desired location.

### BRIEF SUMMARY

Embodiments of the invention are directed to a method of preparing graphene on a SiC substrate selectively on regions of the surface of the SiC substrate that are bombarded with ions and annealed within a volume of the SiC substrate at the bombarded surface, with at least one graphene layer formed at the bombarded regions. The bombarding ions can be C, Si, Au, P, B or any combination thereof. The ions are bombarded at a level of 10¹³ ions/cm² or greater. The annealing can be carried out by heating the entire substrate to a temperature of 1200° C. or more and at a pressure of 1×10⁻⁶ Ton or less. Alternately or additionally, the annealing can be carried out by irradiation of the bombarded surface with one or more high energy beams such as a laser beam.

### BRIEF DESCRIPTION OF DRAWINGS

FIG. 1 shows Raman spectra for pristine 4H—SiC (top dashed line), Au implanted (1×10¹⁶ ions/cm²) 4H—SiC (top solid line), pristine 6H—SiC (bottom dashed line), and Si implanted (5×10¹⁷ Si ions/cm²) 6H—SiC (bottom solid line) after annealing to 1200° C. at 1×10⁻⁶ Torr evidencing selective graphitization (graphene formation), according to an embodiment of the invention, and where the insert shows the resulting Raman spectra for the annealed Au implanted 4H—Si (top) and Si implanted 6H—SiC (bottom) after subtracting the spectra of pristine SiC.

FIG. 2 shows a) Auger electron spectra taken from 50 to 2200 eV of pristine 4H—SiC (top) and Au implanted 4H—SiC (middle) after annealing to 1200° C., and b) Auger spectra of the carbon region for: pristine (top); Au implanted (middle) 4H—SiC after annealing to 1200° C.; and a reference highly oriented pyrolytic graphite (HOPG) (bottom).

FIG. 3 shows scanning electron microscopy (SEM) images of Au implanted 4H—SiC (top) and Si implanted 6H—SiC (bottom) surfaces.

### DETAILED DISCLOSURE

Embodiments of the invention are directed to methods of forming graphene on a substrate of SiC that comprises ion bombardment or ion implantation doping of a selected surface of a SiC substrate followed by selective annealing and nanofabrication. The terms ion bombardment and ion implantation may be used interchangeably herein, as both occur by bombardment of a substrate's surface by ions. In general, ion bombardment and ion implantation doping are differentiated in the literature when the species of implanted ion changes the substrate's properties by interacting with the substrate's atoms. Nevertheless, one or both of these phenomena occur when a substrate's surface is bombarded with ions, with the depth of penetration being determined by the ion's species and energy. Advantages of the method of ion implantation in a SiC substrate for the formation of graphene include: avoidance of conventional lithography processes that leave residue on the substrates surface, which can lower the mobility of graphene and creates unintended doping effects on the graphene produced; avoidance of chemicals that creates disorder in graphene; avoidance of the requirement of an O₂ plasma etching to define the graphene devices, which can induce disorder at the graphene boundaries, or promote degradation of properties; and lowering the annealing temperature for graphene growth on SiC, because of implantation or ion damage in the SiC substrate. The method for forming graphene, according to embodiments of the invention, induces graphene growth selectively in only ion implanted regions, where the amount of graphene formed is determined by the implanted dose, ion species, energy, and any follow-on processing.

Previously, the inventors have demonstrated that bombardment of a surface of a single crystal Si or Ge substrate with C ions can produce an amorphous surface region that allows the formation of graphitic surfaces from the implanted sample upon heating to 500° C. to 1,000° C. under vacuum or a controlled inert atmosphere, Appleton et al., Graphene Processing for Device and Sensor Applications, WO 2010/096646, which is incorporated herein by reference. In an embodiment of the invention, a substrate surface displaying any crystal orientation of any SiC polymorph, for example, 2H—, 4H— or 6H—SiC, is bombarded with energetic ions to damage the bombarded surface. By selecting the ion species, their chemical interaction with the SiC substrate can be controlled. By selecting the energy of the bombarding ions, the depth of ion penetration and the extent of damage beneath the surface can be controlled. By selecting the dose of ions implanted, the degree of damage can be controlled.

The inherent control allowed using ion bombardment/implantation provides a number of options for optimizing the fabrication of graphene from SiC. In embodiments of the invention, the ion bombardment converts the bombarded surface into a partially or completely amorphous SiC layer. Depending on the ion(s) employed and the ion energy used, the surface can be rendered completely amorphous, when using an ion dose in excess of about 10¹³ ions/cm². The ion bombardment breaks Si—C chemical bonds, simultaneously changing the density of the bombarded surface. The bombarded surface comprises broken Si—C bonds that promote Si sublimation to leave a C-rich surface that forms a graphene layer during processing. The process is superior to the known processing of SiC, where SiC crystals are heated to very high temperature, about 1300 to 1700° C. to achieve breakage of the Si—C bonds to permit evaporation, or sublimation, of Si and leave a C rich layer that can be graphitized. Results have shown that the bombarded surface can yield graphene when the SiC samples are annealed at temperatures of 1200° C., which is at least 100° C. below that of processes to form graphene as a layer on non-bombarded SiC (1300° C.).

In another embodiment of the invention, the implanted ions are chosen to control interactions in the damaged crystal, where the damage, for example, dangling Si bonds, enhances carbon diffusion to the surface, promoting the formation of graphene. In one embodiment, the implantation of carbon ions renders the bombarded surface amorphous and provides C atoms at a concentration in excess of a normal SiC surface. Amorphous SiC surfaces begin to crystallize at about 900° C. By providing an appropriate excess of carbon, diffusion of C atoms to the surface occurs with the recrystallization of the SiC in the area adjacent to the carbon surface, which is a beneficial structure for some applications for the resulting graphene, according to embodiments of the invention. In an embodiment of the invention, the implantation of Au ions and/or C ions in SiC, by controlling the amount of C implanted, permits the clean formation of one, two, or more layers of graphene. The Au not only produces the desired SiC damage (bond breaking) but can form SiAu eutectics and/or Au nanoclusters, which can behave as catalysts for the graphitization process. Alternately Au ions and/or Si ions can be implanted, where the Si promotes the migration of the Si to the surface with sublimation and leaving a surface of carbon for formation of the graphene sheet or sheets on the substrate surface.

In another embodiment of the invention, the implanted ions are selected to dope the SiC or promote interactions that are beneficial for specific sensor or other device applications. For examples, P and B implants in SiC render the bombarded surface amorphous, where P is stable and becomes electrically active upon annealing and B redistributes within the sample (Mulpuri V. Rao and Jason A. Gardner, P. H. Chi, O. W. Holland, G. Kelner, J. Kretchmer and M. Ghezzo “Phosphorus and boron implantation in 6H-SiC”, J. Appl. Phys. 81 (10), 1997). These and/or other implanted species can be chosen to achieve beneficial surface modifications that lead to enhanced graphene formation.

In another embodiment of the invention, graphene is produced at low temperatures using implanted ions in combinations that induce desired bonding or interactions that promote graphene formation. For example, an excess of carbon is implanted and diffuses to the surface to form graphene with selected dopants, for example, implanted P that bonds with Si. Hence the Si is tied up by P at or near the implanted surface to liberate the carbon for diffusion to the surface and the formation of graphene.

In another embodiment of the invention, an ion beam used for implantation, or another high energy beam, can be used to anneal the implanted areas. The defects created by ion beams have been shown to stimulate annealing and to promote diffusion of defect areas. Heating during ion implantation, or while doing post ion beam annealing, can effectively transform an implanted surface into a graphene surface. In this manner, and as in the other embodiments above, by controlling the ion species and the processing temperature, graphene formation can be carried out over a range of conditions while simultaneously controlling the underlying crystal substrate.

In embodiments of the invention, any combination of ions and processing conditions can be carried out with ion beam patterning. As indicated above, high temperature processing of SiC that has not been implanted tends to create rough and faceted surfaces, restricting formation of graphene to randomly-located small areas that are flat and uniform. When the graphene is needed for the fabrication of nano or micro electronic sensors or other devices where the graphene is of a small area or in a patterned array, employing the ion beam for patterning is advantageous. Where one wishes to fabricate nanometer or micrometer areas of graphene in an ordered arrangement, the ion implantation process can be focused and otherwise controlled to form graphene only in desired areas, and at a relatively low temperature. Alternatively or additionally, patterned or continuous ion implanted areas can be thermally processed by using one or more focused laser beams that confine thermal annealing only to implanted areas without significantly affecting surrounding areas. In other embodiments, the selective ion beam patterning can be performed using conventional lithographic techniques commonly used in the semiconductor industry, such as masking, exposure, development, laydown, and liftoff. In other embodiments of the invention, a multi-ion beam lithography and processing system can be used to produce nanoscale ion beams for lithographic patterning, where direct-writing, maskless ion implantation, and patterning can be carried out with nanometer precision.

In an embodiment of the invention, one or more focused laser beams are employed to anneal the bombarded SiC surface. In this manner, the thermal budget can be drastically reduced and the heat and resulting graphene formation can be restricted to precise desired areas where the laser beam or beams are focused. Again, the SiC substrate can be patterned by ion beam lithography of the SiC, as above. Such control of the graphene formation, in patterns restricted to only desired nanoscale and/or microscale regions by the use of focused laser beam irradiation of implanted regions, is useful for construction of devices, such as integrated circuits. The laser can be employed in a continuous or pulsed mode for long or short annealing periods, with beam cross-sections that are as large or as small as desired and are uniform in intensity, to the degree permitted by the laser source used. The laser beam can be used at low-powers for very local heating or at high-powers for more extensive melting and re-solidifying the surface, where only the desired nanoscale and/or microscale regions are transformed into graphene by heating with little or no heating of other near and remote portions of the irradiated surface. Such a heating profile is advantageous to situations where other circuit components that can be adversely affected by heating need to be formed on the surface of the SiC substrate prior to graphene formation. The laser induced annealing permits a rapid annealing method that can be adapted to large scale nanofabrication. For example, large ion bombarded areas can be annealed by using scanning laser beams, advantageously restricting the heat to only the bombarded surface while maintaining low temperatures within the remaining substrate or device. In embodiments of the invention, non-equilibrium affects associated with pulsed and scanned lasers can be promoted by the irradiation of the laser beam on specific areas for very short durations, for example, periods of milliseconds, microseconds, or nanoseconds, to impose specific structural effects, where only the irradiated shallow surface regions re-solidify at a very high rate due to thermal conduction to the underlying SiC substrate.

### Methods and Materials

Graphene growth was selectively carried out on 4H—SiC and 6H—SiC after Au and Si implantation, as detailed, below. The Au and Si ion implantation into SiC lowers the graphitization temperature of SiC (T_{G}) from 1300° C. to 1200° C. (T _{G}^{imp}) in implanted regions. Though not to be bound by a mechanism, graphitization temperature decrease is consistent with: an enhancement in Si sublimation, which is consistent with broken Si—C bonds and crystal deformation at the SiC surface, and to surface catalysis by the Au ions. At temperatures above T _{G}^{imp}, but below T_{G}, graphitization selectively occurs at the implanted regions, as measured by scanning electron microscopy (SEM), micro-Raman spectroscopy, and Auger electron spectroscopy (AES). This allows a selective patterning of graphene without the need for any lithography/dry etching techniques.

Commercially available, semi-insulating, polished, C-face 4H—SiC and 6H—SiC II-VI semiconductor wafers were implanted with Au and Si ions at 60 kV with fluences ranging from 1×10¹⁶ to 1×10¹⁷ ions/cm² for Au and 5×10¹⁴ to 5×10¹⁷ ions/cm² for Si. The Au and Si ions were implanted into 2 μm×2 μm and 10 μm×10 μm windows that were separated by 10 μm. Pristine and implanted SiC samples were annealed in a conventional quartz tube oven at 0.5−1×10⁻⁶ Torr at 1200-1300° C. The sample temperature was measured in close proximity, within 5 mm of the SiC samples using a C-type thermocouple. Graphene layers were characterized using AES at 3 keV, SEM, and micro-Raman using a 532 nm laser source.

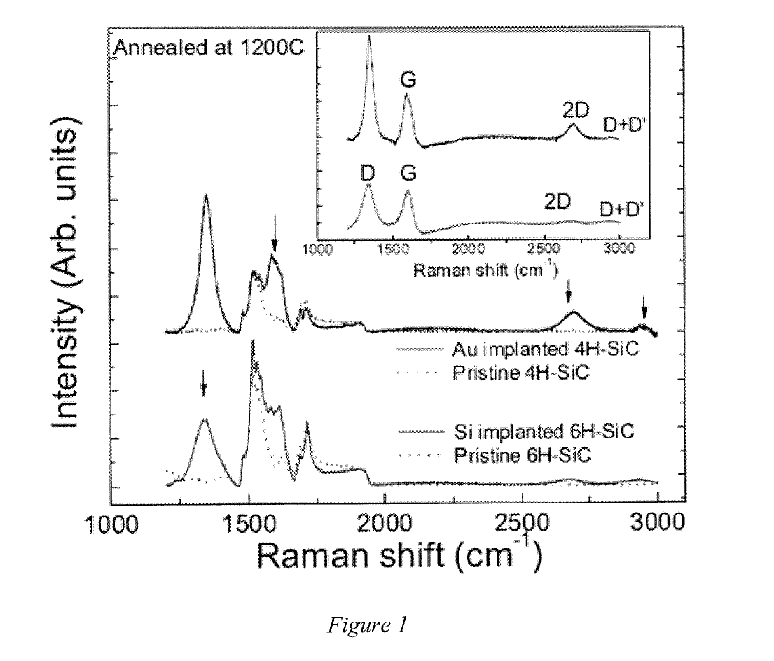

In FIG. 1, Raman spectra are shown for pristine SiC and Au and Si implanted SiC that were annealed to 1200° C. The Raman spectra of the annealed 4H—SiC (top dotted line) and 6H—SiC (bottom dotted line) samples in non-implanted regions are identical to pristine SiC samples that had not been annealed, implying that graphitization did not occur at 1200° C. for non-bombarded regions of either sample. When pristine SiC was annealed to 1300° C., graphitization occurred and samples became conductive. In contrast, implanted regions of both samples begin to graphitize at 1200° C., as indicated by Raman spectra of Au (3×10¹⁶ ions/cm²) implanted 4H—SiC (top solid line) and Si (5×10¹⁷ ions/cm²) implanted 6H-SiC (bottom solid line). The spectra exhibit three prominent peaks (as indicated by arrows in FIG. 1) that identify the surface to be graphitic in nature: G peak (E_{2g} breathing phonon mode) at 1592 cm⁻¹; 2D peak (two-phonon double resonance mode) at 2700 cm⁻¹; and D peak (defect assisted one phonon double resonance mode) at 1350 cm⁻¹, which suggests that graphene layers contain disorder. The disorder does not appear to result from defects induced on the SiC surface during implantation, as an identical D peak occurs in graphene layers that were grown on pristine SiC at 1300° C., which is consistent with the disorder being at least partially attributable to the quality of the SiC as received and/or surface contamination. Where the D peak is comparable to G in intensity, other disorder activated peaks become apparent at 1620 cm⁻¹ (D′ peak) and at 2938 cm⁻¹ (D+D′). Because the D′ peak is in close proximity to the observed G peak, the D′ is not observable and only appears to broaden the G peak. Multi-peak fitting of the region around 1592 cm⁻¹ yields a G peak FWHM value of 40 cm⁻¹. The existence of D′ and D+D′ peaks, and because of the D:G ratio, graphene domain sizes of about 20-200 nm are implied.

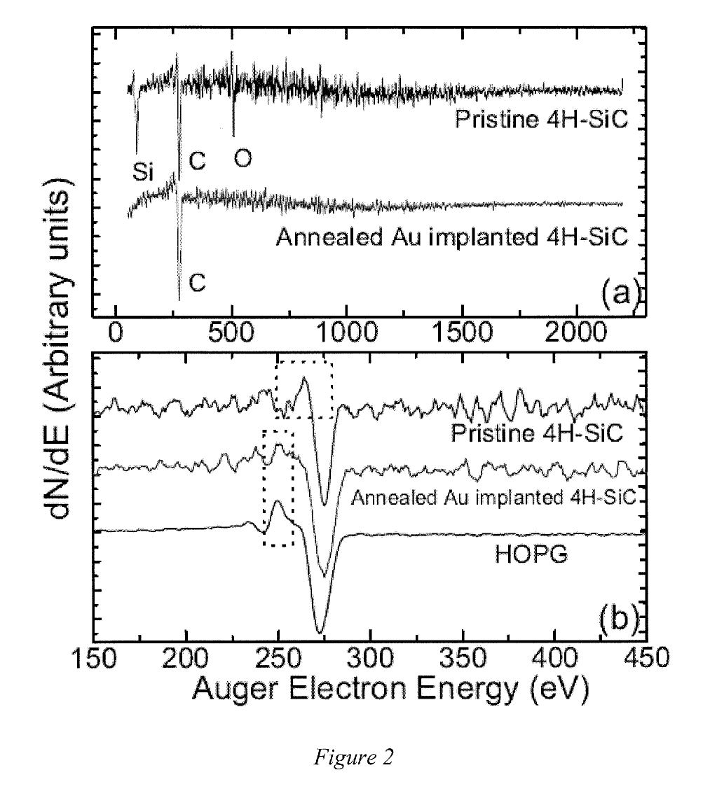

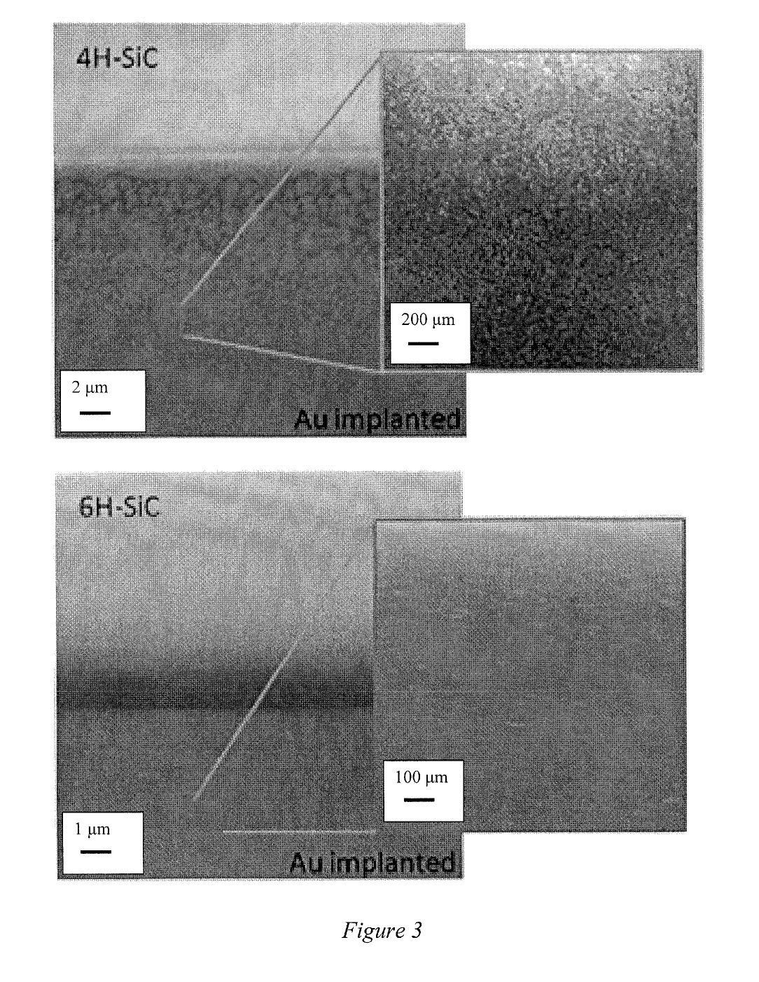

AES, as shown in FIG. 2a, were taken on pristine (top) and implanted SiC (bottom) surfaces that were annealed at 1200° C. Because the pristine SiC does not graphitize at 1200° C., its AES spectrum retains large Si and C peaks consistent with those of a SiC crystal. The observed Si and surface oxide peaks completely disappear upon annealed implanted samples at 1200° C., suggesting that the graphene layers fully cover the surfaces (within a 1.5 μm AES spot size) consistent with micro-Raman data from FIG. 1 and SEM images shown in FIG. 3. Graphene growth, on the C-face of SiC, is known to not be self-limiting and that during graphitization many weakly coupled graphene layers can be grown without any stacking order in isolated graphene. AES only probes a few atomic layers at the surface (3-5 Å); the absence of Si and Au peaks implies that there is a plurality of graphene layers, and that implanted Au particles are not clustered or agglomerated at the surface. As shown in FIG. 2b, the C peaks of SiC (top) and implanted SiC (center) for 1200° C. annealed samples, and of highly oriented pyrolytic graphite (HOPG) (bottom), display equivalent C peak signals positioned at 272 eV, but where the peak shape is sensitive to bonding character in the surface. The C peak of annealed SiC shows a sharp peak at 265 eV (shown in the top dashed square in FIG. 2b), as has been recorded for other silicon carbides. In contrast, the carbon peaks, for HOPG CVD graphite and graphene grown on implanted regions of the annealed SiC sample, display a smooth shoulder at 252 eV (shown in the lower dashed square in FIG. 2b), confirming that the carbon grown on an implanted SiC surface is a graphene layer, in agreement with the G and 2D peaks observed in the Raman spectrum of FIG. 1.

At 1200° C., graphitization was not observed for Si ion dosages less than 5×10¹⁶ ions/cm² and Au ion dosages less than 1×10¹⁶ ions/cm². Surfaces exposed to high energy ions are susceptible to Si-C bond breakage at the surface to enhance Si sublimation from the surface. The lower critical level for dosage by Au ions, relative to Si ions for graphitization at 1200° C., suggests that greater surface damage is inflicted by larger mass ion. The enhancement of Si sublimation from the surface by the bombardment with Au ions may also result from the intermediacy of an Au-Si eutectic. However, as the graphene layers can be grown on SiC surfaces with only implanted Si ions, the formation of a eutectic alone does not account for a lowering of the graphitization temperature.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

We claim:

1. A method of preparing graphene, comprising:
providing a SiC substrate;
bombarding a surface of the SiC substrate with ions; and
annealing a volume of the SiC substrate at the bombarded surface, wherein at least one graphene layer forms at the bombarded surface.

2. The method of claim 1, wherein the ions comprise C, Si, Au, P, B or any combination thereof.

3. The method of claim 1, wherein annealing comprises heating to a temperature of 1200° C. or more and a pressure of 1×10⁻⁶ Torr or less.

4. The method of claim 1, wherein the surface of the SiC substrate is bombarded with a plurality of ions at a level of 10¹³ ions/cm² or greater.

5. The method of claim 1, wherein the surface is bombarded with Si ions at a dosage of 5×10¹⁶ ions/cm² or more and the annealing temperature is 1200° C. or higher.

6. The method of claim 1, wherein the surface is bombarded with Au ions at a dosage of 1×10¹⁶ ions/cm² or more and the annealing temperature is 1200° C. or higher.

7. The method of claim 1, wherein annealing is carried out by irradiation of the bombarded surface with one or more high energy beams.

8. The method of claim 7, wherein the high energy beam is a laser beam.
